(19) United States
(12) Patent Application Publication
(10) Pub. No.: US 2017/0038933 A1
(43) Pub. Date: Feb. 9, 2017

(54) SYSTEMS AND METHODS FOR PROVIDING REMINDERS FOR CONTENT IN SOCIAL NETWORKS

(71) Applicant: Facebook, Inc., Menlo Park, CA (US)

(72) Inventors: Andrew Griggs Hoskins, Palo Alto, CA (US); Elmer Charles Jubb, IV, New York, NY (US); Mayank Kumar Gupta, Jacksonville, FL (US); Nicholas Olaf Sundin, Austin, TX (US)

(21) Appl. No.: 14/820,384

(22) Filed: Aug. 6, 2015

(51) Int. Cl. G06F 3/0484; H04L 12/58

(52) U.S. Cl. CPC G06F 3/0484; H04L 51/24; H04L 51/32

(57) ABSTRACT

Systems, methods, and non-transitory computer-readable media can identify a content item within a social networking system for which a reminder is to be provided. A selection specifying one or more conditions for providing the reminder can be received. It can be determined that the one or more conditions are satisfied. The reminder can be provided via a notification within the social networking system when the one or more conditions are satisfied. The content item can be accessible via the reminder.

### FIELD OF THE INVENTION

The present technology relates to the field of providing content. More particularly, the present technology relates to techniques for providing reminders for content in social networks.

### BACKGROUND

Today, people often utilize computing devices (or systems) for a wide variety of purposes. Users can use their computing devices, for example, to interact with one another, create content, share content, and access content. In some cases, a user of a social networking system (or service) can utilize his or her computing device to provide, post, share, and access various content items, such as status updates, images, videos, articles, and links, via the social networking system. In some instances, the user can view or access such content via a newsfeed or various other channels within the social networking system.

Under conventional approaches to providing content, if the user desires to view a particular content item at a later time, the user can bookmark or save the particular content item. However, often times the user may forget that he or she has bookmarked or saved the particular content item. In some cases, a significant amount of time can have passed before the user realizes that the particular content item was bookmarked or saved. By the time the user remembers the particular bookmarked or saved content item, that content item may no longer be interesting or relevant to the user. As such, conventional approaches to providing content can be inconvenient and inefficient. Such conventional approaches can create challenges for or reduce the overall user experience associated with accessing content in social networks.

### SUMMARY

Various embodiments of the present disclosure can include systems, methods, and non-transitory computer readable media configured to identify a content item within a social networking system for which a reminder is to be provided. A selection specifying one or more conditions for providing the reminder can be received. It can be determined that the one or more conditions are satisfied. The reminder can be provided via a notification within the social networking system when the one or more conditions are satisfied. The content item can be accessible via the reminder.

In an embodiment, a notification badge that indicates a presence of the notification can be presented. One or more user interactions to access the content item via the reminder can be detected. The content item can be provided when the one or more user interactions are detected.

In an embodiment, the providing of the content item when the one or more user interactions are detected can include navigating to at least one of a web service associated with the content item, an application associated with the content item, a social networking system permalink associated with the content item, or a uniform resource locator (URL) associated with the content item.

In an embodiment, the receiving of the selection can occur via a mobile interface of the social networking system. The selection can be received from a user of the social networking system. The one or more conditions can be satisfied when the user is determined to be accessing a desktop interface of the social networking system.

In an embodiment, the one or more conditions can be satisfied when a particular amount of time has passed. The particular amount of time can be defined based at least in part on the selection.

In an embodiment, the one or more conditions can be satisfied when a user of the social networking system is determined to be within an allowable proximity from a particular location. The selection can be received from the user. The particular location can be defined based at least in part on the selection.

In an embodiment, the one or more conditions can be satisfied when a first user of the social networking system is determined to be within an allowable proximity from a second user of the social networking system. The selection can be received from the first user. The second user can be identified based at least in part on the selection.

In an embodiment, the one or more conditions can be satisfied when a particular life event has occurred within the social networking system for at least one of a first user or a second user of the social networking system. The selection can be received from the first user. The particular life event can be defined based at least in part on the selection.

In an embodiment, at least one of a first option or a second option can be presented. The first option can be for editing the one or more conditions prior to the reminder being provided. The second option can be for providing the reminder again at a later time after the providing of the reminder has already occurred.

In an embodiment, it can be determined, at a time subsequent to the receiving of the selection, that the content item has become inaccessible to a user of the social networking system. The content item can be prevented from being accessible to the user via the reminder.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example social content reminder module configured to facilitate providing reminders for content in social networks, according to an embodiment of the present disclosure.

FIG. 2A illustrates an example reminder conditions module configured to facilitate providing reminders for content in social networks, according to an embodiment of the present disclosure.

FIG. 2B illustrates an example reminder providing module configured to facilitate providing reminders for content in social networks, according to an embodiment of the present disclosure.

FIG. 3 illustrates an example scenario associated with providing reminders for content in social networks, according to an embodiment of the present disclosure.

FIG. 4 illustrates an example scenario associated with providing reminders for content in social networks, according to an embodiment of the present disclosure.

FIG. 5 illustrates an example scenario associated with providing reminders for content in social networks, according to an embodiment of the present disclosure.

FIG. 6A illustrates an example method associated with providing reminders for content in social networks, according to an embodiment of the present disclosure.

FIG. 6B illustrates an example method associated with providing reminders for content in social networks, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Reminders for Content in Social Networks

People use computing devices (or systems) for a wide variety of purposes. Computing devices can provide different kinds of functionality. Users can utilize their computing devices to produce information, access information, and share information. In some cases, users can utilize computing devices to interact or engage with a social networking system (i.e., a social networking service, a social network, etc.). For example, users can provide, post, or publish content items, such as text, notes, status updates, links, pictures, videos, and audio, via the social networking system.

In some instances, content items can be provided or presented through a feed, such as a newsfeed of the social networking system, for the user view or access. In some cases, content items can be provided or presented through other channels of the social networking system, such as a user profile page, a user timeline, an entity page, a group page, an event page, a message, etc.

In some cases, a user of the social networking system may encounter a particular content item that is interesting to him or her at the time. However, the user may be too busy or it may otherwise be inappropriate for the user to view, consume, or access the particular content item at the time. Instead, the user may desire to view, consume, or otherwise access the particular content item at a later time. Conventional approaches can sometimes enable the user to bookmark or save the particular content item. The user can also send himself or herself a message with a link to the content item as an attempt to remind himself or herself to access the content item at a later time. However, in accordance with conventional approaches, often times the user may forget that the particular content item has been bookmarked, saved, or sent in the message to himself or herself. As such, an interest or relevancy level of the particular content item with respect to the user can decrease over time. In some cases, by the time the user remembers to access the content item, the content item may no longer be interesting or relevant to the user. Accordingly, conventional approaches can be inconvenient, inefficient, and ineffective. Such conventional approaches can create challenges for and reduce the overall user experience associated with accessing content in social networks.

Therefore, an improved approach can be beneficial for addressing or alleviating various concerns associated with conventional approaches. The disclosed technology can provide reminders for content in social networks. Various embodiments of the present disclosure can identify a content item within a social networking system for which a reminder is to be provided. A selection specifying one or more conditions for providing the reminder can be received. It can be determined that the one or more conditions are satisfied. The reminder can be provided via a notification within the social networking system when the one or more conditions are satisfied. The content item can be accessible via the reminder. It is contemplated that there can be many variations and/or other possibilities.

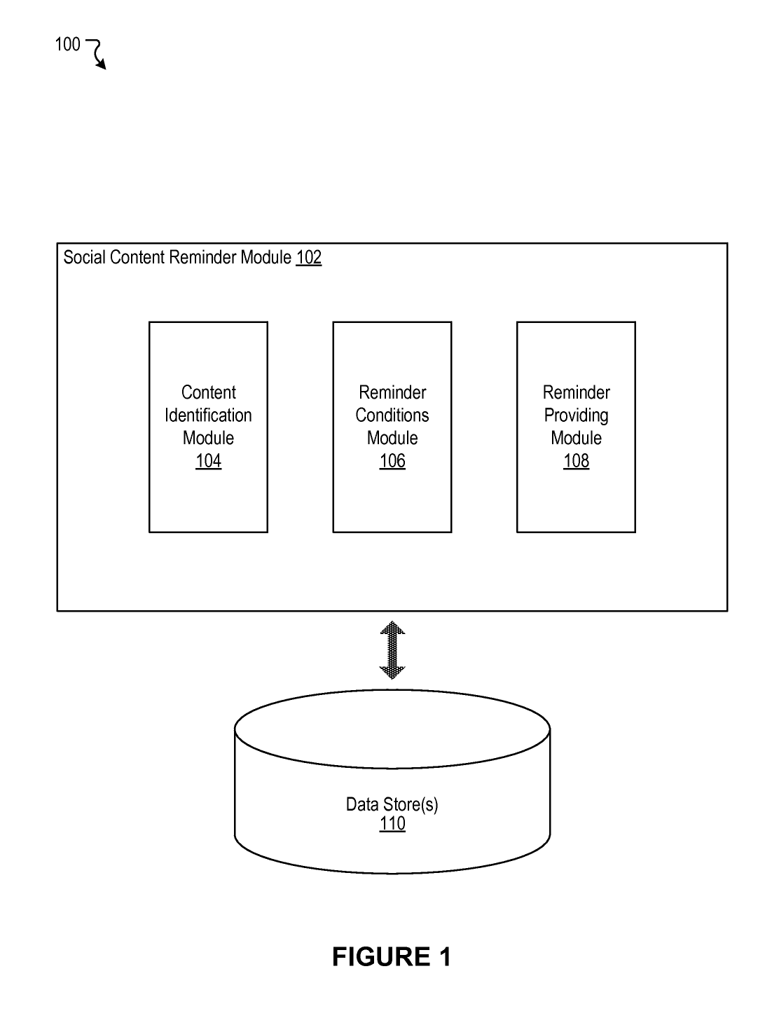

FIG. 1 illustrates an example system 100 including an example social content reminder module 102 configured to facilitate providing reminders for content in social networks, according to an embodiment of the present disclosure. As shown in the example of FIG. 1, the social content reminder module 102 can include a content identification module 104, a reminder conditions module 106, and a reminder providing module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

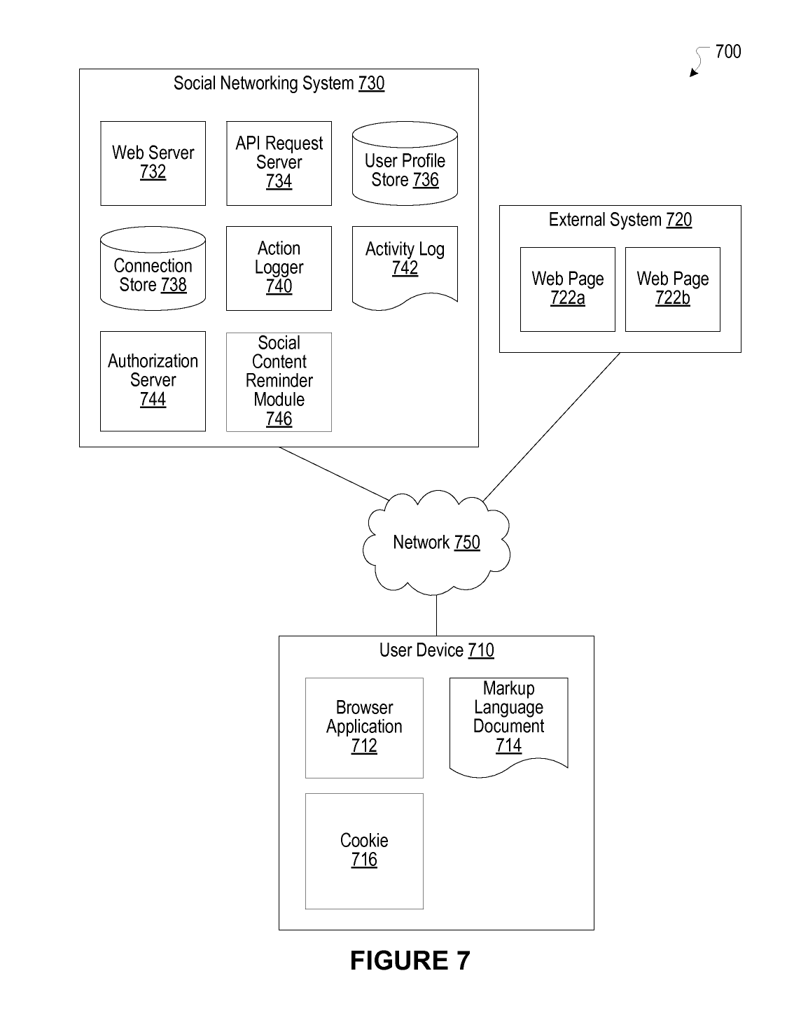

In some embodiments, the social content reminder module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the social content reminder module 102 can be implemented, in part or in whole, as software running on one or more computing devices or systems, such as on a user or client computing device. For example, the social content reminder module 102 or at least a portion thereof can be implemented as or within an application (e.g., app), a program, or an applet, etc., running on a user computing device or a client computing system, such as the user device 710 of FIG. 7. In another example, the social content reminder 102 or at least a portion thereof can be implemented using one or more computing devices or systems that include one or more servers, such as network servers or cloud servers. In some instances, the social content reminder module 102 can, in part or in whole, be implemented within or configured to operate in conjunction with a social networking system (or service), such as the social networking system 730 of FIG. 7. It should be understood that there can be many variations or other possibilities.

The content identification module 104 can be configured to facilitate identifying a content item within a social networking system for which a reminder is to be provided. The content item within the social networking system can also be referred to as social content or content in a social network. In some embodiments, the content identification module 104 can identify the content item within the social networking system based on (i.e., based at least in part on) one or more commands, such as one or more user interactions or user selections. In one example, a user of the social networking system can be browsing through various content items, such as via a newsfeed or a page within the social networking system. The user can encounter a particular content item that is interesting to the user. The user wants to view or access, or finish viewing or accessing, the particular content item, but decides that it would be more appropriate to do so at a later time (and/or at a different place). Thus, in this example, the user can utilize the disclosed technology to set a reminder for the social networking system to remind the user to view or access the particular content item, or to finish doing so, at a later time. For instance, the particular content item can be identified as the content item for which the reminder is to be provided when the user opens a menu associated with the particular content item and selects an option to set up the reminder for the particular content item. It should be understood that this example is provided for illustrative purposes and that many variations are possible.

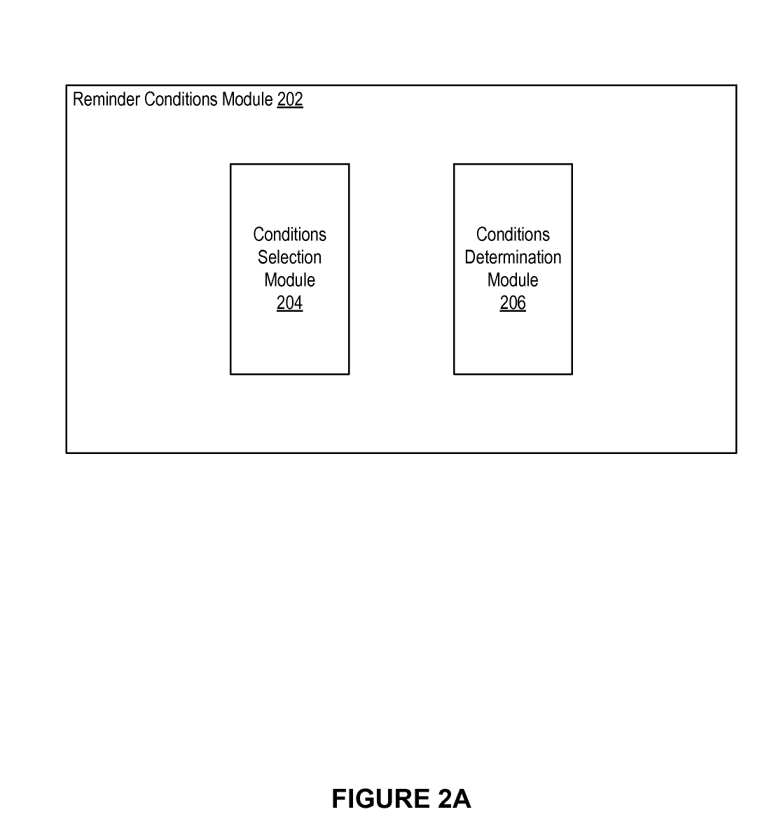

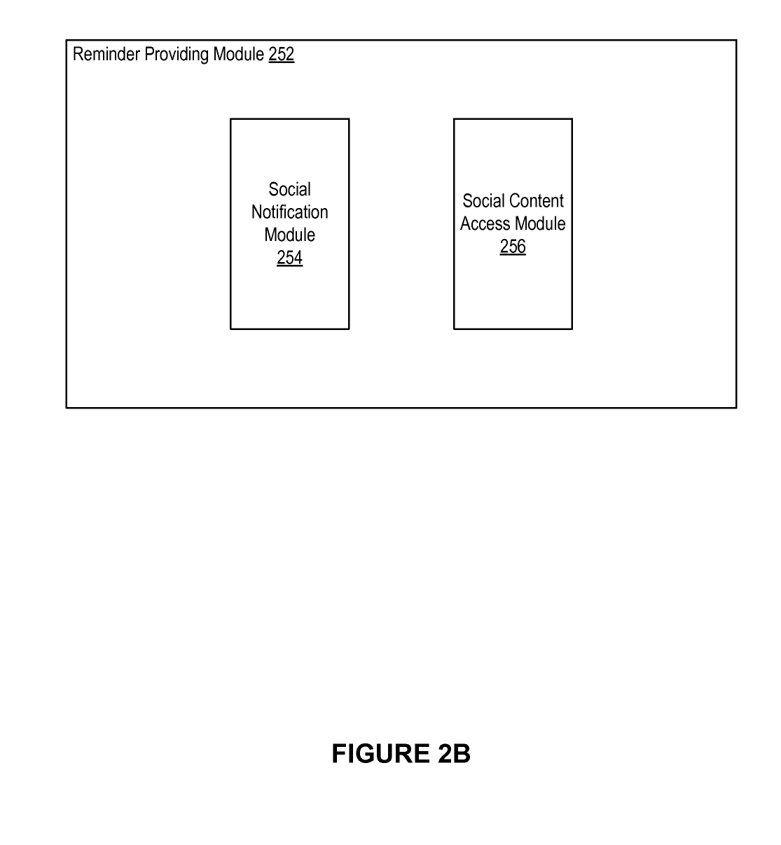

The reminder conditions module 106 can be configured to facilitate receiving a selection specifying one or more conditions for providing the reminder. Continuing with the previous example, when the user opens the menu and selects the option to set up the reminder for the particular content item, the user can select the one or more conditions which must first be satisfied before the reminder can be provided. Moreover, the reminder conditions module 106 can be configured to facilitate determining that the one or more conditions are satisfied. For instance, if the user selects the one or more conditions to require the reminder to be provided after an hour has passed, then the reminder conditions module 106 can determine that the conditions are satisfied when the hour has passed. More details regarding the reminder conditions module 106 will be provided below with reference to FIG. 2A.

The reminder providing module 108 can be configured to facilitate providing the reminder via a notification within the social networking system when the one or more conditions are satisfied. The content item can also be accessible via the reminder provided using the notification. For example, when the one or more conditions for providing the reminder are satisfied, the reminder providing module 108 can cause a social networking system notification to be presented or provided to the user who set up the reminder. The user can interact with the reminder to view or access the content item. The reminder providing module 108 will be discussed in more detail below with reference to FIG. 2B.

Furthermore, in some embodiments, the social content reminder module 102 can be configured to communicate and/or operate with the at least one data store 110, as shown in the example system 100. The at least one data store 110 can be configured to store and maintain various types of data. In some implementations, the at least one data store 110 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user locations, user specified settings, content produced or posted by users, and various other types of user data. In some embodiments, the at least one data store 110 can store information that is utilized by the social content reminder module 102. For instance, the at least one data store 110 can store the content item identified by the content identification module 104 as well as metadata or other information associated with the content item. Furthermore, the data store 110 can store information associated with conditions for reminders, which can be utilized by the reminder conditions module 106. It is contemplated that there can be many variations or other possibilities.

FIG. 2A illustrates an example reminder conditions module 202 configured to facilitate providing reminders for content in social networks, according to an embodiment of the present disclosure. In some embodiments, the reminder conditions module 106 of FIG. 1 can be implemented as the example reminder conditions module 202. As shown in FIG. 2A, the reminder conditions module 202 can include a conditions selection module 204 and a conditions determination module 206.

In some embodiments, the reminder conditions module 202 can utilize the conditions selection module 204 to facilitate receiving a selection specifying one or more conditions for providing a reminder for a content item within a social networking system. In some implementations, the reminder conditions module 202 can utilize the conditions determination module 206 to facilitate determining that the one or more conditions are satisfied, such that the reminder can be provided. The reminder can, for example, help a user of the social networking system to remember to view, consume, or otherwise access the content item. In some cases, the conditions selection module 204 can receive the selection from the user. The user can set up the reminder for the content item via the selection. The user can also specify the one or more conditions in the selection. For example, the user can specify, via the selection, that the reminder is to be provided at a certain time and/or location.

In some implementations, there can be an option to access for the content item. The menu can enable the user to make various selections and choose various preferences or settings for the content item. In one example, for each content item in the social networking system, there can be a respective interactive element, such as a button, a clickable element/icon, or an element/icon that can be tapped via a touch screen, that enables a selection to be made in order to cause a respective reminder to be provided for each content item. In some cases, the interactive element only appears during a mouse hover operation. In some instances, the interactive element is provided independent of mouse hover operations. It is understood that many variations are possible.

In some instances, the selection received by the conditions selection module 204 can specify that the one or more conditions are satisfied when a particular amount of time has passed. The particular amount of time can be defined based at least in part on the selection. The conditions determination module 206 can determine when the particular amount of time has passed. For example, the user can set the reminder for the content item to be provided in one hour. In another example, the reminder can be set to be provided tonight. In a further example, the user can set the reminder for tomorrow, for this weekend, for next week, for next month, or for next year, etc.

In some cases, the selection can specify that the one or more conditions are satisfied when the user is determined to be within an allowable proximity from a particular location (e.g., at the particular location, sufficiently near the particular location, etc.). The particular location can be defined based at least in part on the selection received by the conditions selection module 204. For instance, the particular location can correspond to an address, a landmark, an event location, the user's workplace, the user's home, etc. In one example, the one or more conditions can cause the reminder to be provided when location data associated with the user indicates that the user has arrived at, or at least within a specified threshold distance from, the particular location defined in the selection. The conditions determination module 206 can receive or acquire the location data and determine, based on the location data, that the user is at or sufficiently close to the particular location. Examples of the location data associated with the user can include, but are not limited to, Global Positioning System (GPS) data from a computing device of the user, cellular triangulation data from the computing device of the user, Wi-Fi data from the computing device of the user, Bluetooth data from the computing device of the user, or location check-in data provided by the user or a social connection of the user, etc.

Moreover, in some instances, a first user of the social networking system can set the reminder for the content item based on his or her social connections, including a second user of the social networking system. The first user can make a selection specifying that the one or more conditions are satisfied when the first user is determined to be within an allowable proximity from the second user. The second user can be identified based at least in part on the first user's selection, which is received by the conditions selection module 204. In one example, location data associated with the first user and location data associated with the second user can be determined or acquired by the conditions determination module 206. If the conditions determination module 206 determines, based on the respective location data for the first and the second users, that the first user (e.g., the first user's computing device) and the second user (e.g., the second user's computing device) are within a specified threshold distance from each other, then the one or more conditions can be satisfied. Then the reminder for the content item can be provided to the first user.

Additionally, in some cases, the one or more conditions can be satisfied when a particular life event has occurred within the social networking system for at least one of a first user or a second user of the social networking system. The particular life event can be defined based at least in part on a selection made by the first user. The conditions selection module 204 can receive the selection. The conditions determination module 206 can determine whether or not the particular life event has occurred. If the particular life event has occurred, then the reminder can be provided for the first user. In one example, a user can set a reminder to help the user to remember to access a content item when he or she becomes engaged, gets married, has an anniversary, has a child, has a birthday, etc. In another example, the user can set the reminder to be provided when another user has a life event.

Furthermore, in some instances, the conditions selection module 204 can detect or determine that a selection associated with a reminder has been received from a user via a mobile interface of the social networking system. For instance, the user can log into his or her social networking account using a mobile computing device (or system) and can access the social networking system through the social networking system's mobile website or mobile application. Using the mobile interface, the user can set up the reminder for the content item via the selection. In this example, the user can specify, via the selection, that the one or more conditions are satisfied when the user is determined to be accessing a desktop interface of the social networking system. As such, when the conditions determination module 206 detects or determines that the user has later logged into his or her account at the social networking system's desktop (or full) version website, the one or more conditions can be considered satisfied and the reminder for the content item can be provided to the user (i.e., to the user's account). Again, it is contemplated that many variations are possible. For example, in some cases, the selection and/or the conditions can be received from any type of social networking interface and the conditions can be independent of the type of social networking interface.

FIG. 2B illustrates an example reminder providing module 252 configured to facilitate providing reminders for content in social networks, according to an embodiment of the present disclosure. In some embodiments, the reminder providing module 108 of FIG. 1 can be implemented as the example reminder providing module 252. As shown in FIG. 2B, the reminder providing module 252 can include a social notification module 254 and a social content access module 256.

In some implementations, the reminder providing module 252 can utilize the social notification module 254 to facilitate providing the reminder for the content item via the notification within the social networking system when the one or more conditions are satisfied. The reminder providing module 252 can utilize the social content access module 256 to enable accessibility of the content item via the reminder (and/or via the notification). In some cases, the social networking system has already implemented a notification system. As such, the social notification module 254 can utilize, at least in part, the notification system of the social networking system to provide the reminder via the notification (e.g., a social notification). In some embodiments, the social content access module 256 can cause the reminder and/or the notification to be linked to the content item.

Furthermore, in some implementations, the social notification module 254 (and/or the notification system of the social networking system) can facilitate presenting a notification badge that indicates a presence of the notification. Moreover, the social content access module 256 can detect one or more user interactions to access the content item via the reminder (and/or the notification). The social content access module 256 can further cause the content item to be provided when the one or more user interactions are detected. In one example, the social notification module 254 (and/or the notification system of the social networking system) can display an icon indicating a number of new or unread notifications including the notification for the reminder. The social content access module 256 can detect that the user has clicked on, tapped on, or touched the reminder in the notification. As a result, the content item can be presented or provided to the user. More details regarding notifications are provided in U.S. patent application Ser. No. 14/567,218, filed on Dec. 11, 2014 and titled “User-Aware Notification Delivery”, which is incorporated by reference herein in its entirety.

In some cases, the social content access module 256 can facilitate the providing of the content item by navigating to at least one of a web service associated with the content item, an application associated with the content item, a social networking system permalink associated with the content item, or a uniform resource locator (URL) associated with the content item, etc. Again, it should be understood that there can be many variations or other possibilities.

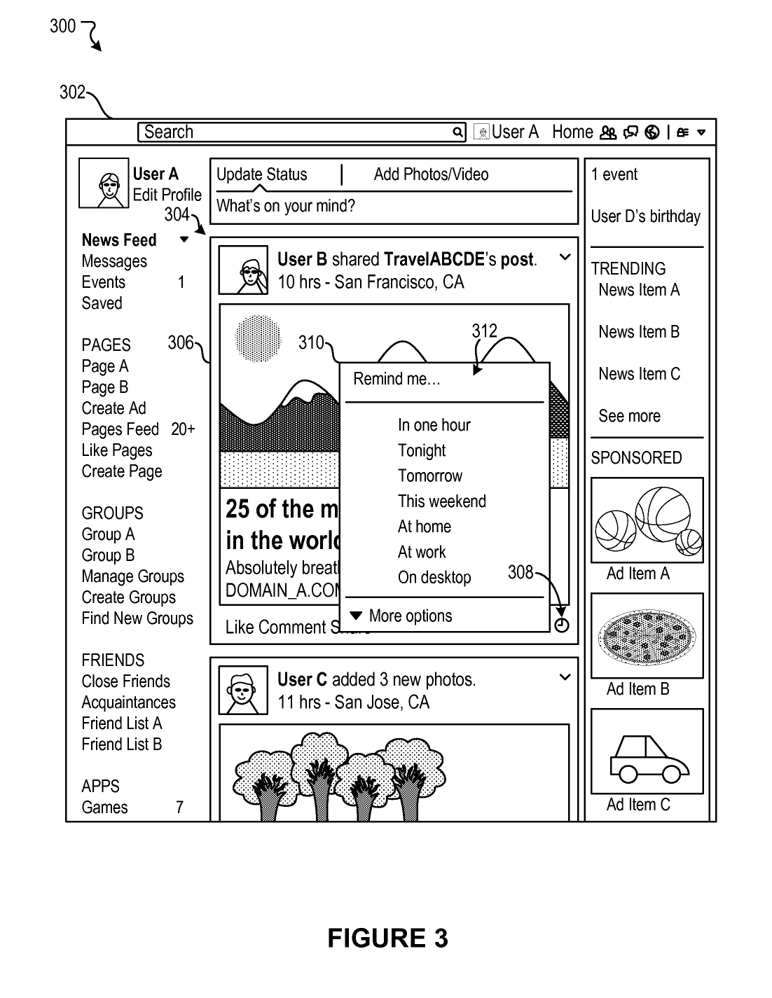

FIG. 3 illustrates an example scenario 300 associated with providing reminders for content in social networks, according to an embodiment of the present disclosure. The example scenario 300 illustrates an interface 302 for utilizing a social networking system, such as the social networking system 730 of FIG. 7). As shown in the example of FIG. 3, the interface 302 can provide a newsfeed 304 for a user, User A. The newsfeed 304 can present various content items within the social networking system to User A. One of the content items presented to User A is a post 306 from an entity, TravelABCDE, that is also shared by User B.

In this example, User A decides to view or access the post 306 at a later time. As such, User A can interact with (e.g., click on, tap on, etc.) an interactive element 308 that causes one or more options for the post 306 to be available, such as via a menu 310. Then User A can select a reminder 312 for this post 306. As shown in this example, User A can set the reminder 312 to be provided in one hour, tonight, tomorrow, this weekend, at home, at work, or via a desktop interface, etc. It should be appreciate that this example scenario 300 is provided for illustrative purposes and that many variations are possible. For instance, in some cases, the interactive element can correspond to a down arrow icon that provides a drop-down menu.

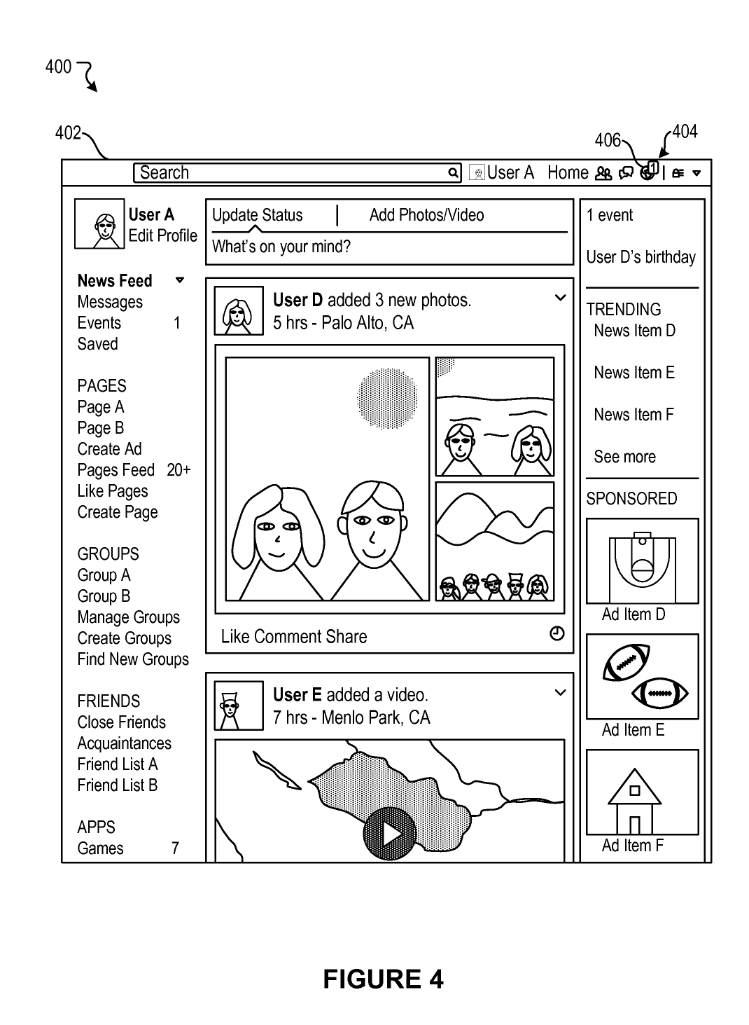

FIG. 4 illustrates an example scenario 400 associated with providing reminders for content in social networks, according to an embodiment of the present disclosure. The example scenario 400 illustrates a social networking system interface 402, such as the interface 302 of FIG. 3. In the example scenario 400, one or more conditions for providing the reminder (e.g., reminder 312 in FIG. 3) have been determined to be satisfied. As a result, the reminder can be provided via a notification within the social networking system. Accordingly, the interface 402 shows a notification badge 404 with respect to a notification icon 406. The notification badge 404 can indicate that a new notification, the notification for the reminder, is available.

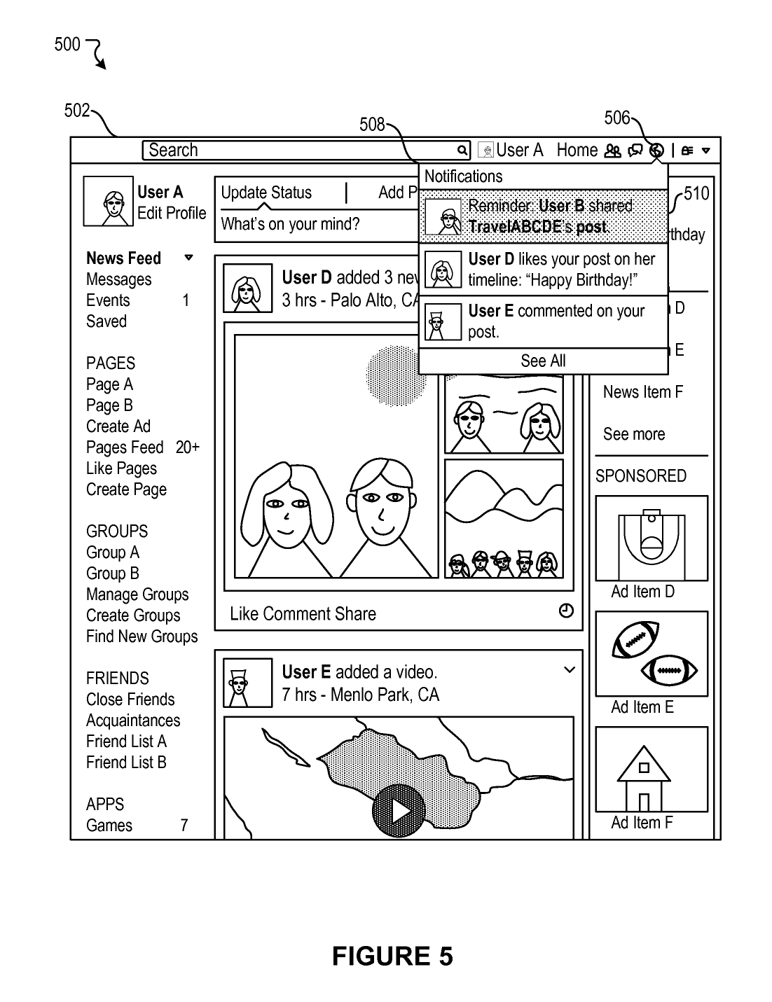

FIG. 5 illustrates an example scenario 500 associated with providing reminders for content in social networks, according to an embodiment of the present disclosure. The example scenario 500 illustrates a social networking system interface 502, such as the interface 402 of FIG. 4. In the example scenario 500, User A has clicked on or otherwise interacted with a notification icon 506 (e.g., notification icon 406 in FIG. 4). As a result, a notification list 508 can be presented to User A. In the notification list 508, the reminder (e.g., reminder 312 in FIG. 3) can be provided to User A via a notification 510. Furthermore, User A can access the content item (e.g., TravelABCDE's post 306 in FIG. 3) by clicking on or otherwise interacting with the reminder provided via the notification 510. Again, it is contemplated that this example and other examples provided herein are for illustrative purposes and that there can be many variations or other possibilities. For instance, in some cases, there can be a pop-up notification for the reminder.

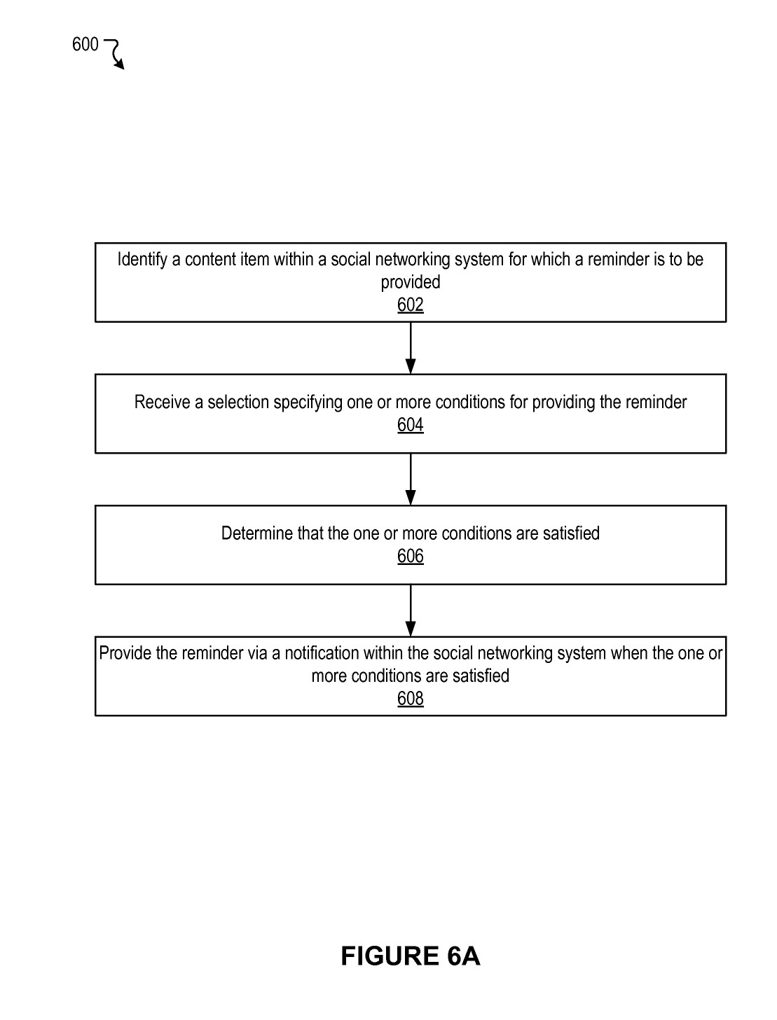

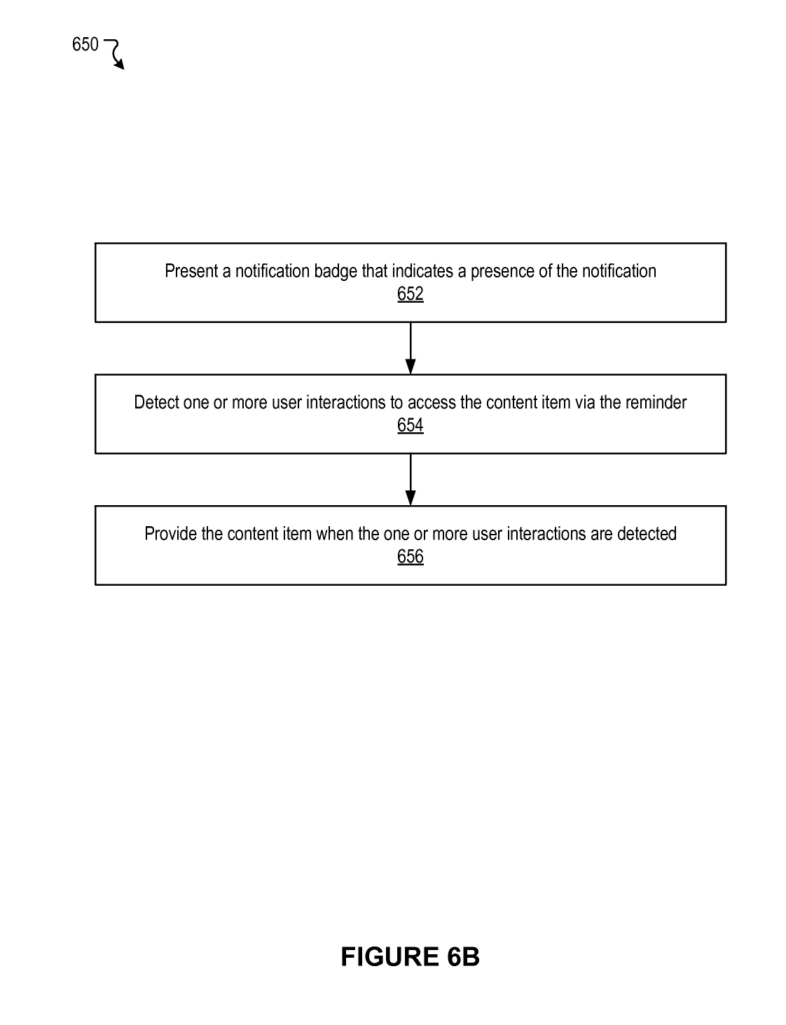

FIG. 6A illustrates an example method 600 associated with providing reminders for content in social networks, according to an embodiment of the present disclosure. It should be appreciated that there can be additional, fewer, or alternative steps performed in similar or alternative orders, or in parallel, within the scope of the various embodiments unless otherwise stated.

At block 602, the example method 600 can identify a content item within a social networking system for which a reminder is to be provided. At block 604, the example method 600 can receive a selection specifying one or more conditions for providing the reminder. At block 606, the example method 600 can determine that the one or more conditions are satisfied. At block 608, the example method 600 can provide the reminder via a notification within the social networking system when the one or more conditions are satisfied. The content item can be accessible via the reminder.

FIG. 6B illustrates an example method 650 associated with providing reminders for content in social networks, according to an embodiment of the present disclosure. Again, it should be understood that there can be additional, fewer, or alternative steps performed in similar or alternative orders, or in parallel, within the scope of the various embodiments unless otherwise stated.

At block 652, the example method 650 can present a notification badge that indicates a presence of the notification. At block 654, the example method 650 can detect one or more user interactions to access the content item via the reminder. At block 656, the example method 650 can provide the content item when the one or more user interactions are detected.

In some embodiments, at least one of a first option or a second option can be presented. The first option can be for editing the one or more conditions prior to the reminder being provided. For example, if the user decides to change the time and/or location at which the reminder is to be provided, the user can do so via the first option. The second option can be for providing the reminder again at a later time after the providing of the reminder has already occurred. For instance, the user can “snooze” the reminder, similar to how an alarm clock can be “snoozed”.

In some embodiments, it can be determined, at a time subsequent to the receiving of the selection, that the content item has become inaccessible to a user of the social networking system. The content item can be prevented from being accessible to the user via the reminder. In one example, the content item is deleted after the reminder is set. As a result, the reminder can be removed or there can be an indication that the content item is no longer available or no longer accessible. In another example, one or more privacy settings for the content item are changed after the setting of the reminder such that the user can no longer access the content item. Thus, the reminder can be removed or there can be an indication that the content item is unavailable or inaccessible. In a further example, if the content item is an ephemeral content item, then a message stating that the content item may not be available later can be provided when the user tries to set a reminder for the ephemeral content item, or the option to set the reminder can be removed.

In some embodiments, reminders can be set for previously saved content items. In some cases, examples of content items within the social networking system (i.e., social content, content in social networks, etc.) can include, but are not limited to, any post, video, image, audio clip, advertisement, newsfeed article, story, and/or object representable by a node in a social graph, etc.

In some embodiments, one or more reminders can be automatically suggested to the user. In some cases, reminders can be suggested to the user based on historical data associated with the user within the social networking system (e.g., social browsing history, social profile history, social check-in history, etc.). In one example, when User A is at work and comes across a video from User B, User A will usually set a reminder to view the video later that night. As such, next time User A is at work and comes across a video from User B, a suggestion to set a reminder to view User B's video later that night can be suggested to User A.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System

### Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the SilverLight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include a social content reminder module 746. The social content reminder module 746 can, for example, be implemented as the social content reminder module 102 of FIG. 1. As discussed previously, it should be appreciated that there can be many variations or other possibilities. Other features of the social content reminder module 746 are discussed herein in connection with the social content reminder module 102.

### Hardware Implementation

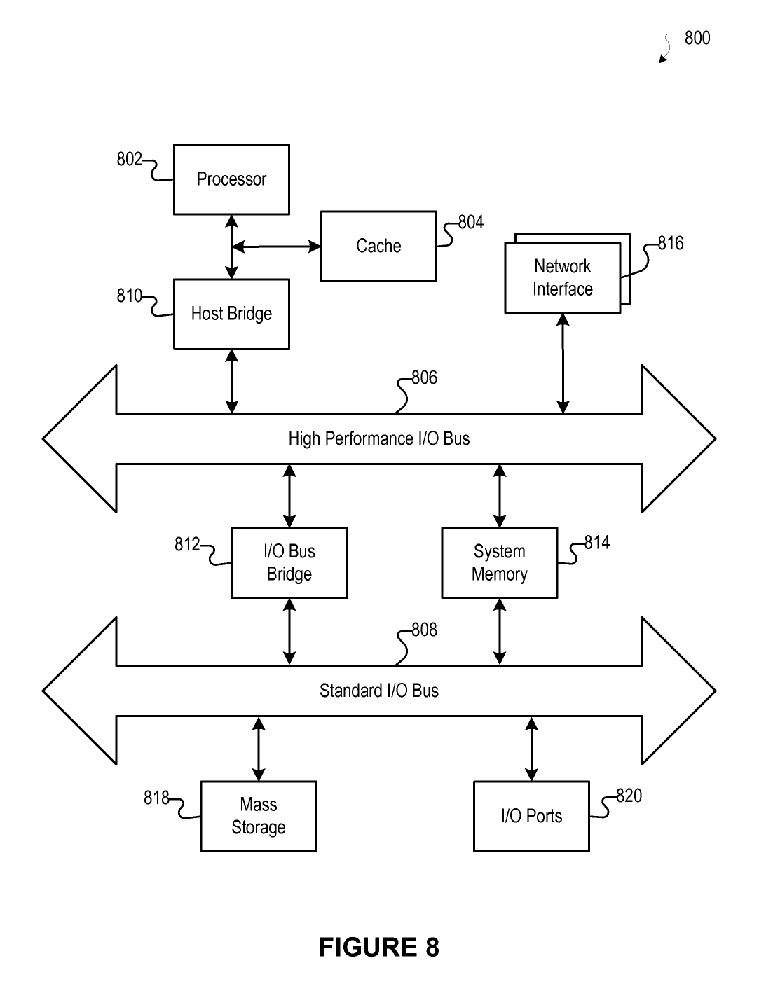

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
identifying, by a computing system, a content item within a social networking system for which a reminder is to be provided;
receiving, by the computing system, a selection specifying one or more conditions for providing the reminder;
determining, by the computing system, that the one or more conditions are satisfied; and
providing, by the computing system, the reminder via a notification within the social networking system when the one or more conditions are satisfied, wherein the content item is accessible via the reminder.

2. The computer-implemented method of claim 1, further comprising:
presenting a notification badge that indicates a presence of the notification;
detecting one or more user interactions to access the content item via the reminder; and
providing the content item when the one or more user interactions are detected.

3. The computer-implemented method of claim 2, wherein the providing of the content item when the one or more user interactions are detected includes navigating to at least one of a web service associated with the content item, an application associated with the content item, a social networking system permalink associated with the content item, or a uniform resource locator (URL) associated with the content item.

4. The computer-implemented method of claim 1, wherein the receiving of the selection occurs via a mobile interface of the social networking system, wherein the selection is received from a user of the social networking system, and wherein the one or more conditions are satisfied when the user is determined to be accessing a desktop interface of the social networking system.

5. The computer-implemented method of claim 1, wherein the one or more conditions are satisfied when a particular amount of time has passed, and wherein the particular amount of time is defined based at least in part on the selection.

6. The computer-implemented method of claim 1, wherein the one or more conditions are satisfied when a user of the social networking system is determined to be within an allowable proximity from a particular location, wherein the selection is received from the user, and wherein the particular location is defined based at least in part on the selection.

7. The computer-implemented method of claim 1, wherein the one or more conditions are satisfied when a first user of the social networking system is determined to be within an allowable proximity from a second user of the social networking system, wherein the selection is received from the first user, and wherein the second user is identified based at least in part on the selection.

8. The computer-implemented method of claim 1, wherein the one or more conditions are satisfied when a particular life event has occurred within the social networking system for at least one of a first user or a second user of the social networking system, wherein the selection is received from the first user, and wherein the particular life event is defined based at least in part on the selection.

9. The computer-implemented method of claim 1, further comprising:
presenting at least one of a first option to edit the one or more conditions prior to the reminder being provided or a second option to provide the reminder again at a later time after the providing of the reminder has already occurred.

10. The computer-implemented method of claim 1, further comprising:
determining, at a time subsequent to the receiving of the selection, that the content item has become inaccessible to a user of the social networking system; and
preventing the content item from being accessible to the user via the reminder.

11. A system comprising:
at least one processor; and
a memory storing instructions that, when executed by the at least one processor, cause the system to perform:
identifying a content item within a social networking system for which a reminder is to be provided;
receiving a selection specifying one or more conditions for providing the reminder;
determining that the one or more conditions are satisfied; and
providing the reminder via a notification within the social networking system when the one or more conditions are satisfied, wherein the content item is accessible via the reminder.

12. The system of claim 11, wherein the instructions cause the system to further perform:
presenting a notification badge that indicates a presence of the notification;
detecting one or more user interactions to access the content item via the reminder; and
providing the content item when the one or more user interactions are detected.

13. The system of claim 11, wherein the receiving of the selection occurs via a mobile interface of the social networking system, wherein the selection is received from a user of the social networking system, and wherein the one or more conditions are satisfied when the user is determined to be accessing a desktop interface of the social networking system.

14. The system of claim 11, wherein the one or more conditions are satisfied when a particular amount of time has passed, and wherein the particular amount of time is defined based at least in part on the selection.

15. The system of claim 11, wherein the one or more conditions are satisfied when a user of the social networking system is determined to be within an allowable proximity from a particular location, wherein the selection is received from the user, and wherein the particular location is defined based at least in part on the selection.

16. A non-transitory computer-readable storage medium including instructions that, when executed by at least one processor of a computing system, cause the computing system to perform:
identifying a content item within a social networking system for which a reminder is to be provided;
receiving a selection specifying one or more conditions for providing the reminder;
determining that the one or more conditions are satisfied; and
providing the reminder via a notification within the social networking system when the one or more conditions are satisfied, wherein the content item is accessible via the reminder.

17. The non-transitory computer-readable storage medium of claim 16, wherein the instructions cause the system to further perform:
presenting a notification badge that indicates a presence of the notification;
detecting one or more user interactions to access the content item via the reminder; and
providing the content item when the one or more user interactions are detected.

18. The non-transitory computer-readable storage medium of claim 16, wherein the receiving of the selection occurs via a mobile interface of the social networking system, wherein the selection is received from a user of the social networking system, and wherein the one or more conditions are satisfied when the user is determined to be accessing a desktop interface of the social networking system.

19. The non-transitory computer-readable storage medium of claim 16, wherein the one or more conditions are satisfied when a particular amount of time has passed, and wherein the particular amount of time is defined based at least in part on the selection.

20. The non-transitory computer-readable storage medium of claim 16, wherein the one or more conditions are satisfied when a user of the social networking system is determined to be within an allowable proximity from a particular location, wherein the selection is received from the user, and wherein the particular location is defined based at least in part on the selection.
